(19) United States
(12) Patent Application Publication
(10) Pub. No.: US 2007/0137213 A1
(43) Pub. Date: Jun. 21, 2007

(54) Turbine wheelspace temperature control

(75) Inventors: Chris Rickert, Greenville, SC (US); Jeffrey S. Palmer, Greer, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/305,169

(22) Filed: Dec. 19, 2005

(51) Int. Cl. F02C 7/12

(52) U.S. Cl. 60/782; 60/806

(57) ABSTRACT

A method of controlling wheelspace temperature in a gas turbine comprising: (a) extracting air from a compressor used to supply compressed air to the gas turbine for combustion; (b) supplying air extracted in step (a) to the wheelspaces in the gas turbine; and (c) controlling flow of air supplied in step (b) to achieve a desired wheelspace temperature.

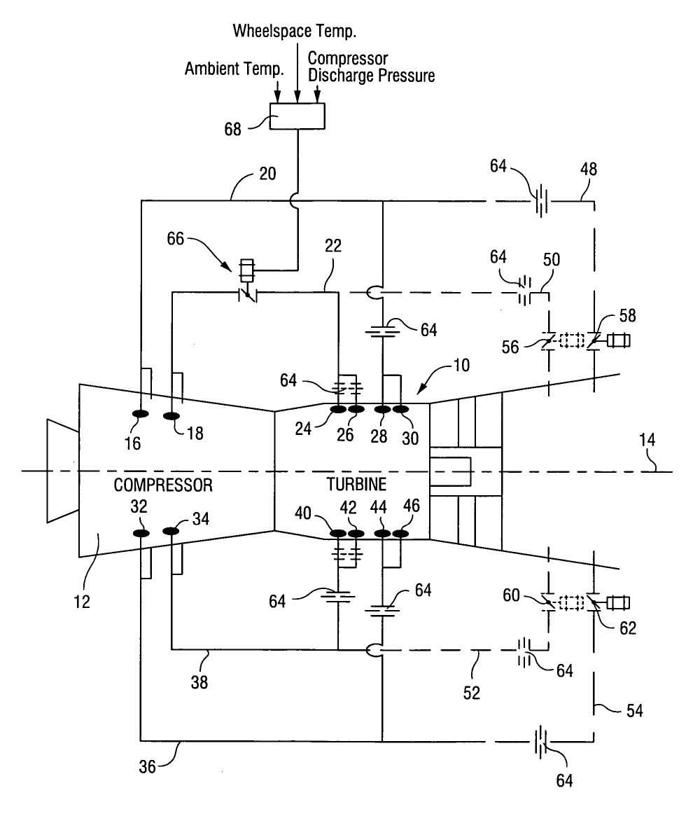

### BACKGROUND OF THE INVENTION

This invention relates to the operation of land-based power generating turbines and, more specifically, to the control of turbine wheelspace temperatures.

Turbine wheelspace are those areas between the rotor discs or wheels that support respective rows of turbine blades. Thus, the wheelspaces are located radially inward of the mainstream flow of gas through the adjacent stages. Typically, the radially inner discs are heated by conduction from the rotor blades, ingress of mainstream flow into the wheelspace cavities, and windage heating within the wheelspaces.

The actual turbine wheelspace temperatures are a function of turbine output, ambient temperature and unit degradation or condition. Wheelspace temperatures are currently monitored and alarms are used to signal higher than acceptable temperature readings. Currently, operators reduce power to prevent such alarms for otherwise unacceptably high wheelspace temperatures. This practice causes a loss of revenue and potentially limits total plant output on hotter days. Another option for achieving reductions in wheelspace temperatures include shutting the unit down, changing orifice plates in the cooling supply circuit, and then restarting the unit. This procedure, however, causes shutdown/start up delays and requires frequent adjustment as a function of the outside ambient temperature.

Another option includes a reduction in cooling flow, thereby having the opposite effect on wheelspace temperatures. Setting higher wheelspace temperatures will result in increased performance but may also reduce the life cycle of the unit.

### BRIEF DESCRIPTION OF THE INVENTION

The present invention allows the operator to increase (or decrease) cooling flow, based on the condition of the unit, ambient temperature, and the indicated wheelspace temperature through the use of a modulating valve. Adjustments can be made to permit extending range operation by reducing cooling/flow and/or improved rotor life in adverse conditions by increasing cooling flow. In this regard, the continuous monitoring of the system can keep the unit running at higher output on hot days below wheelspace temperature limits, and can provide flexibility to support other operational priorities and extended ranges.

The current practice of extracting air from the turbine compressor and supplying purge/cooling air to the wheelspace cavities through fixed orifices is retained, but larger orifices are employed so as to allow a newly added modulating control valve to increase or decrease the flow of compressor-extracted cooling air to the wheelspace cavities. In addition, only one control valve need be installed in the plural conduits typically employed to supply extracted air to the wheelspaces. In other words, one control valve is sufficient to provide the anticipated adjustment capability to increase or decrease the compressor extraction air to the wheelspaces.

In the exemplary embodiment, the invention controls compressor extraction airflows back to cool and purge the turbine wheelspaces. The cooling flow is controlled on a substantially continuous basis through a modulating valve that is actuated to permit the desired amount of flow from the compressor extraction to the turbine wheelspace. The amount of flow is determined by control settings selected to achieve a desired wheel space temperature.

In one embodiment, an open-loop control arrangement is provided wherein the modulating valve can be set in a given position and if the monitored wheelspace temperatures are not acceptable, the operator can move the valve to another position.

In a second embodiment, a closed-loop arrangement is provided wherein the valve position is changed automatically to keep the wheelspace temperature at a set point.

Accordingly, in one aspect the present invention relates to a method of controlling wheelspace temperature in a gas turbine comprising: (a) extracting air from a compressor used to supply compressed air to the gas turbine primarily for combustion; (b) supplying air extracted in step (a) to the wheelspaces in the gas turbine; and (c) controlling flow of air supplied in step (b) to achieve a desired wheelspace temperature.

In another aspect, the invention relates to a method of controlling wheelspace temperature in a gas turbine comprising: (a) extracting air from a compressor used to supply compressed air to the gas turbine primarily for combustion; (b) supplying air extracted in step (a) to the wheelspaces in the gas turbine; and (c) controlling flow of air supplied in step (b) so as to achieve a desired wheelspace temperature; wherein step (c) is carried out by installing a bleed control valve in a conduit supplying extracted cooling air to the wheelspaces, and wherein control settings for the bleed control valve are selected to achieve the desired wheelspace temperature consistent with increasing service life of the gas turbine.

In still another aspect, the invention relates to apparatus for supplying extracted air from a compressor to wheelspaces in a gas turbine, the apparatus comprising: one or more air supply conduits extending between the compressor and the turbine wheelspaces; at least one control valve in one or more conduits; and means for controlling the control valve as a function of at least ambient temperature and wheelspace temperature.

The invention will now be described in detail in connection with the single drawing FIGURE identified below.

### BRIEF DESCRIPTION OF THE DRAWING

The single drawing FIGURE illustrates in schematic form a system for controlling compressor extraction air used to cool and purge the turbine wheel space in accordance with an exemplary embodiment of the invention.

### DETAILED DESCRIPTION OF THE DRAWINGS

With reference to the drawing FIGURE, a gas turbine component 10 is supplied with compressed air via a compressor 12 that may be axially aligned on a single shaft represented by a longitudinal center line 14. Most of the compressed air is supplied to the turbine combustors (not shown), but some is extracted for other uses. For example, in one circuit, cooling air is extracted from the compressor at extraction ports 16, 18 and supplied via lines 20, 22 to the wheelspace areas or cavities (or, simply, wheelspaces) within the turbine via inlet ports 24, 26, 28 and 30. In another circuit, cooling air is extracted from compressor ports 32, 34 and supplied via lines 36, 38 to the wheelspaces via inlet ports 40, 42, 44 and 46.

Circuits are also provided for temporary use, during start-up for example, where excess compressor air is dumped to the turbine exhaust via lines 48, 50, 52 and 54 under the control of respective on-off valves 56, 58, 60 and 62. In conventional systems, flow is controlled in the various circuits conduits or lines by means of fixed orifices 64. It will be understood that the number of extraction ports, inlets, etc., may be varied to suit specific applications and piping configurations.

In accordance with this invention, the cooling flow to the turbine wheelspaces can be enhanced by controlling flow through at least one of the cooling circuits by a bleed or modulating control valve, although it will be understood that additional control valves may be employed if desired. In accordance with the exemplary embodiment, a modulating control valve 66 is inserted in the line 22 in a closed-loop arrangement so as to permit adjustment of compressor-extracted supplied cooling air (via port 18) to the turbine wheelspaces (via inlets 24, 26) as needed. In this regard, the valve 66 may be controlled by a microprocessor 68 and programmed to automatically vary the amount of cooling flow as a function of, for example, the condition of the unit (as determined by, for example, compressor discharge pressure), ambient temperature, and the instantaneous indicated wheelspace temperature. Since the controls are based on current temperature readings, adjustments can be made automatically to either permit extended range operation and/or improved rotor life under adverse conditions. In other words, continuous monitoring of the system may be employed to keep the unit running at higher output on hot days, but also provides flexibility to support other operational priorities and extended ranges. In this regard, the valve 66 may be adjusted toward a wide open position to increase cooling flow and thereby increase service life, or it may be adjusted toward a closed position to increase performance at the expense of service life. In order to render valve 60 compatible with existing purge air arrangements, the orifices 64 in line 22 may be enlarged to facilitate the desired range of flow while providing a maximum flow limit. Alternatively, the orifice 64 may be removed but it is preferred to retain the orifices for establishing some degree of control in the event of valve failure.

In a variation of the above arrangement, an open-loop arrangement may be employed when the valve 66 is adjusted to one position and if the desired wheelspace temperature is not achieved, the operator can selectively move the valve to another position, with the process repeated as necessary to achieve the desired temperature or temperature within a desired range.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of controlling wheelspace temperature in a gas turbine comprising:
(a) extracting air from a compressor used to supply compressed air to the gas turbine primarily for combustion;
(b) supplying air extracted in step (a) to the wheelspaces in the gas turbine; and
(c) controlling flow of air supplied in step (b) to achieve a desired wheelspace temperature.

2. The method of claim 1 wherein step (c) is carried out by installing a bleed control valve in a conduit supplying extracted cooling air to the wheelspaces, and wherein control settings for the bleed control valve are selected automatically to achieve the desired wheelspace temperature.

3. The method of claim 1 wherein controlled settings for the bleed control valve are input manually.

4. The method of claim 1 wherein step (b) includes supplying extracted air to the wheelspaces through plural inlets.

5. The method of claim 1 wherein step (c) is carried out to reduce wheelspace temperature.

6. The method of claim 1 wherein step (c) is carried out to increase wheelspace temperature.

7. The method of claim 1 wherein step (c) is carried out as a function of turbine unit condition as measured by compressor discharge pressure.

8. The method of claim 1 wherein step (c) is carried out as a function of ambient temperature and wheelspace temperature.

9. The method of claim 2 wherein at least one fixed orifice lies downstream of the control valve.

10. A method of controlling wheelspace temperature in a gas turbine comprising:
(a) extracting air from a compressor used to supply compressed air to the gas turbine primarily for combustion;
(b) supplying air extracted in step (a) to the wheelspaces in the gas turbine; and
(c) controlling flow of air supplied in step (b) so as to achieve a desired wheelspace temperature;
wherein step (c) is carried out by installing a bleed control valve in a conduit supplying extracted cooling air to the wheelspaces, and wherein control settings for the bleed control valve are selected to achieve the desired wheelspace temperature consistent with increasing service life of the gas turbine.

11. The method of claim 10 wherein step (b) includes supplying extracted air to the wheelspaces through plural inlets.

12. The method of claim 10 wherein step (c) is performed automatically.

13. The method of claim 10 wherein step (c) is carried out as a function of turbine unit condition as measured by compressor discharge pressure.

14. The method of claim 10 wherein step (c) is carried out as a function of ambient temperature and wheelspace temperature.

15. The method of claim 10 wherein at least one fixed orifice lies downstream of the control valve.

16. Apparatus for supplying extracted air from a compressor to wheelspaces in a gas turbine, the apparatus comprising:
one or more air supply conduits extending between the compressor and the turbine wheelspaces;
at least one control valve in one or more conduits; and
means for controlling the control valve as a function of at least ambient temperature and wheelspace temperature.

17. Apparatus according to claim 16 wherein said means also operates as a function of compressor discharge pressure.
